(19) United States
(12) Patent Application Publication
(10) Pub. No.: US 2015/0053443 A1
(43) Pub. Date: Feb. 26, 2015

(54) SINGLE POINT DEPTH CONTROL ASSEMBLY FOR AN AGRICULTURAL TILLAGE IMPLEMENT

(71) Applicant: CNH Industrial America LLC, New Holland, PA (US)

(72) Inventors: Michael G. Kovach, Morton, IL (US); Rick L. Gerber, Roanoke, IL (US)

(73) Assignee: CNH INDUSTRIAL AMERICA LLC, New Holland, PA (US)

(21) Appl. No.: 14/453,108

(22) Filed: Aug. 6, 2014

Related U.S. Application Data
(60) Provisional application No. 61/868,134, filed on Aug. 21, 2013.

(51) Int. Cl. A01B 63/26

(52) U.S. Cl. CPC A01B 63/26
USPC 172/668

(57) ABSTRACT

An agricultural tillage implement includes a carriage frame assembly having a pull hitch extending in a travel direction, an axle with a rocker arm extending therefrom, a tube pivotally attached to an end of the rocker arm, and a depth control assembly associated with the tube. The depth control assembly includes a slide surrounding the tube and slidably movable along the tube, and a rod threaded with an opening associated with the slide. The rod has an opposing end with a crank arm and a handle at a distal end of the crank arm. The handle is configured as a ballast to prevent inadvertent adjustment of the depth control assembly during operation of the tillage implement.

This is a non-provisional application based upon U.S. provisional patent application Ser. No. 61/868,134, entitled “SINGLE POINT DEPTH CONTROL ASSEMBLY FOR AN AGRICULTURAL TILLAGE IMPLEMENT”, filed Aug. 21, 2013 which is incorporated herein by reference.

### BACKGROUND OF THE INVENTION

1. Field of the Invention

The present invention relates to agricultural implements, and, more particularly, to agricultural field tillage implements.

2. Description of the Related Art

Farmers utilize a wide variety of tillage implements to prepare soil for planting. Some such implements include two or more sections coupled together to perform multiple functions as they are pulled through the fields by a tractor, for example, a cultivator/harrow which is capable of simultaneously tilling and leveling the soil in preparation for planting. This implement includes a cultivator that is towed by a tractor in a harrow that is towed by the cultivator.

In one type of tilling operation, rows or gangs of circular disk blades are pulled through the soil at variable depths to break up clods or lumps of soil, as well as old plant material to provide a more amenable soil structure for planting and to level the soil surface. The gangs of disks are arranged on frames that extend generally laterally with respect to the direction of movement through a field and more particularly are angled with respect to the direction of movement.

It is known to provide a single point hydraulic depth control with such a tillage implement. The depth control is a manually adjustable rod which sets a stop position of a hydraulic lift cylinder used for raising and lowering the tillage implement. The depth control may sometimes bind during the adjustment process, and may move during operation which allows the selected depth to change.

What is needed in the art is a tilling implement with a depth control that is easy to adjust and stays in the adjusted position during operation.

### SUMMARY OF THE INVENTION

The present invention provides a tillage implement with a single point depth control assembly having a balanced crank arm which does not bind during adjustment, and is biased to a selected adjustment position using a weighted handle at the end of the crank arm.

In one form, the invention is an agricultural tillage implement including a carriage frame assembly having a pull hitch extending in a travel direction, an axle with a rocker arm extending therefrom, a tube pivotally attached to an end of the rocker arm, and a depth control assembly associated with the tube. The depth control assembly includes a slide surrounding the tube and slidably movable along the tube, and a rod threaded with an opening associated with the slide. The rod has an opposing end with a crank arm and a handle at a distal end of the crank arm. The handle is configured as a ballast to prevent inadvertent adjustment of the depth control assembly during operation of the tillage implement.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 illustrates a tillage implement having an embodiment of disk blades having a support of disk blades embodying the present invention being pulled by a tractor;

FIG. 2 is a perspective view of the tillage implement of FIG. 1;

FIG. 3 is a perspective view of the tillage implement shown in FIGS. 1 and 2;

FIG. 4 is a fragmentary perspective view of the tillage implement shown in FIGS. 1-3;

FIG. 5 is a fragmentary perspective view of the depth control assembly shown on the tillage implement of FIGS. 3 and 4; and

FIGS. 6 and 7 are perspective views of the depth control assembly shown in FIGS. 3-5.

Corresponding reference characters indicate corresponding parts throughout the several views. The exemplification set out herein illustrates one embodiment of the invention and such exemplification is not to be construed as limiting the scope of the invention in any manner.

### DETAILED DESCRIPTION OF THE INVENTION

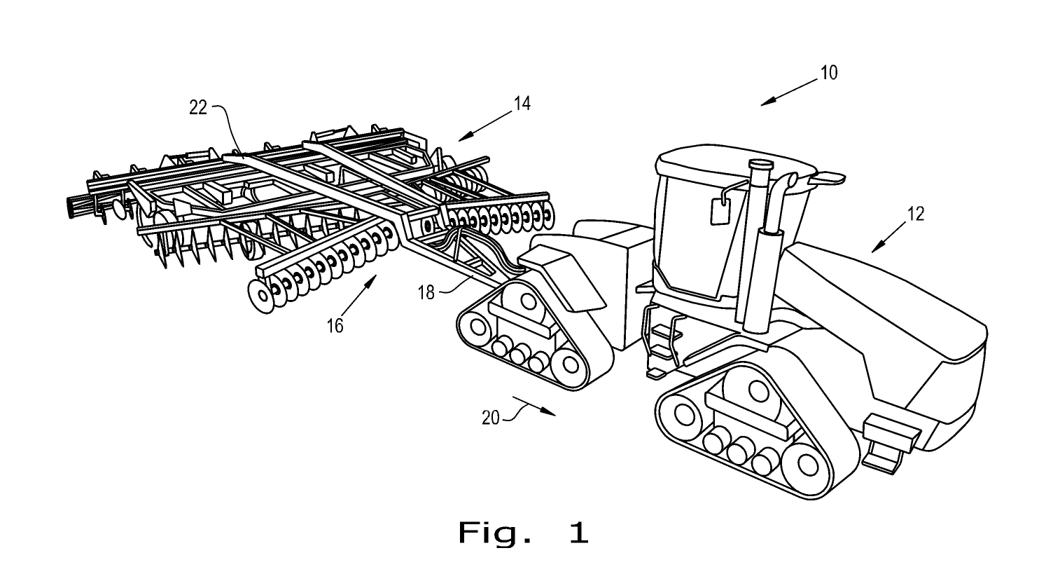

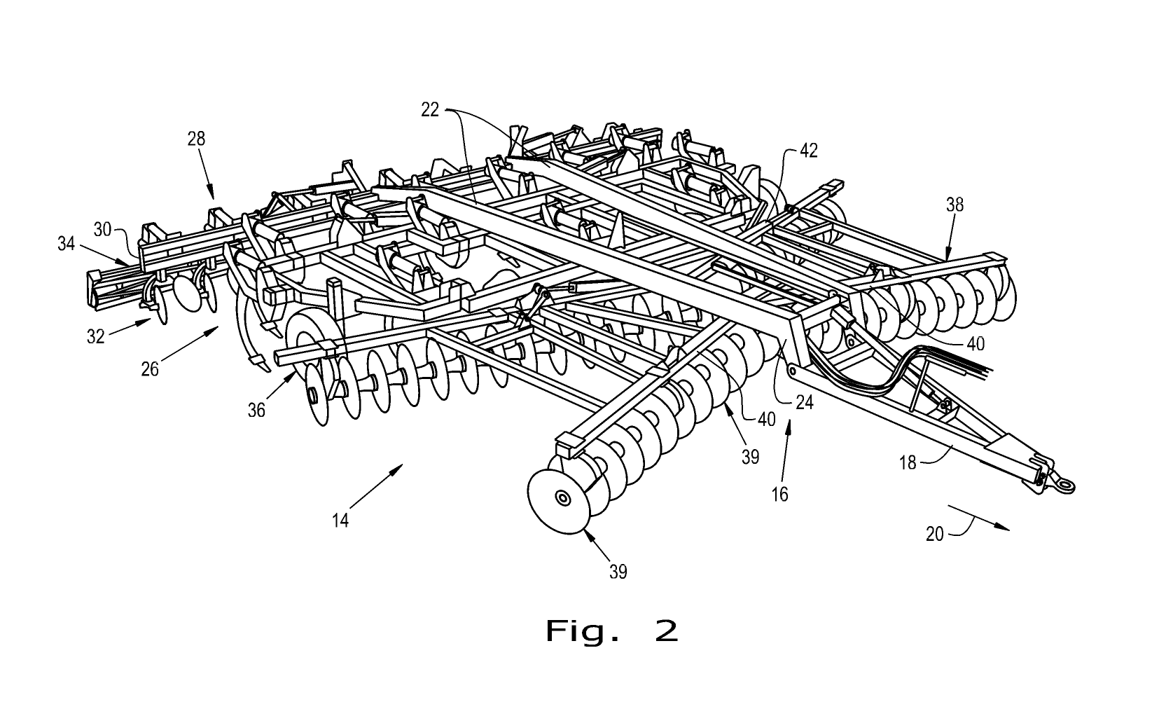

Referring now to the drawings, and more particularly to FIGS. 1 and 2, there is shown a tillage apparatus 10 which generally includes a tractor 12 and an agricultural tillage implement 14 for tilling and finishing soil prior to seeding.

Agricultural tillage implement 14 is configured as a multi-section field disk ripper 14, and includes a carriage frame assembly 16. Carriage frame assembly 16 is the section that is directly towed by a traction unit, such as agricultural tractor 12. Carriage frame assembly 16 includes a pull hitch 18 generally extending in a travel direction 20, and forward and aft directed carrier frame members 22 which are coupled with and extend from pull hitch 18. Reinforcing gusset plates 24 may be used to strengthen the connection between pull hitch 18 and carrier frame members 22. Carriage frame assembly 16 generally functions to carry a shank frame 26 for tilling the soil, and a rear implement 28 for finishing the soil. Shank frame 26 includes a plurality of arcuate shanks with tilling points at their lower end for tilling the soil. Rear implement 28 includes a secondary frame 30, leveling blades 32 and rolling (aka, crumbler) basket assemblies 34, which coact with each other to finish the soil in preparation for planting. Leveling blades 32 and rolling basket assemblies 34 are both attached to secondary frame 30.

Wheels 36, only one of which is shown, are actuated from tractor 12 to raise or lower the carrier frame members 22 to place the tillage implement 14 in a transport position with the wheels 36 supporting the implement above the ground and an operating position in which the tillage implement 14 is used to till the soil.

Carrier frame members 22 also carry a disk frame assembly 38 which provides support for gangs of disk blades 39 positioned forward from shank frames 26. The disk frame assembly 38 includes fore and aft frame members 40 and 42, respectively, to which the gangs of disk blades 39 are connected.

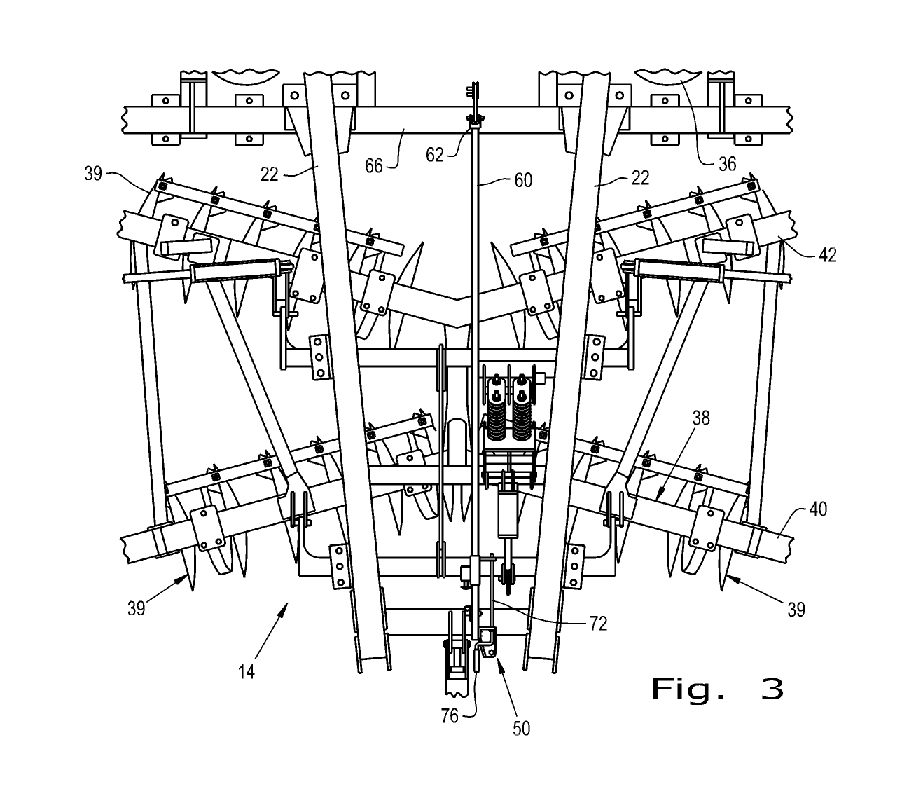

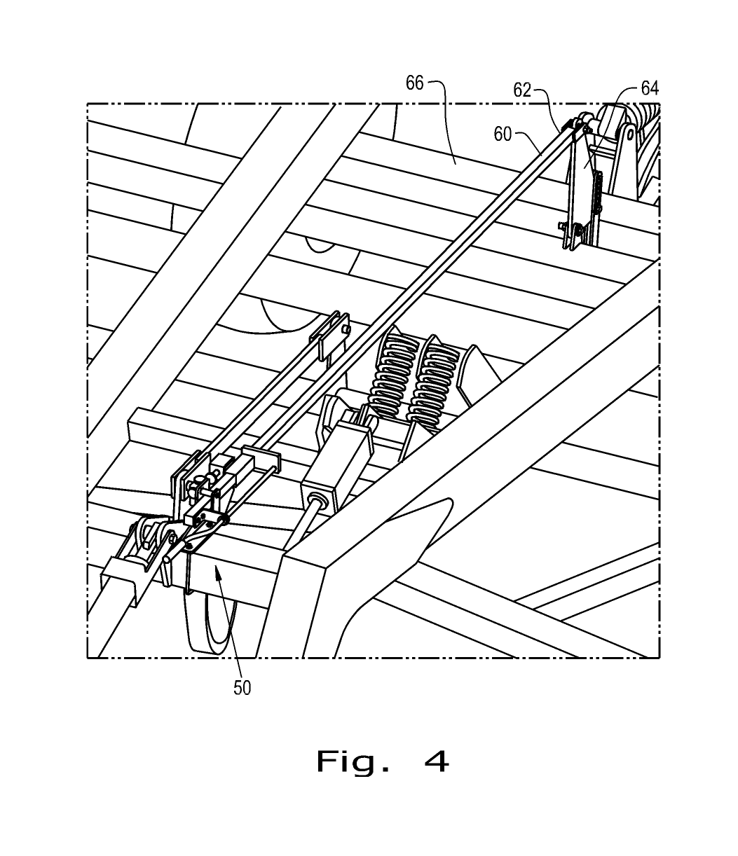

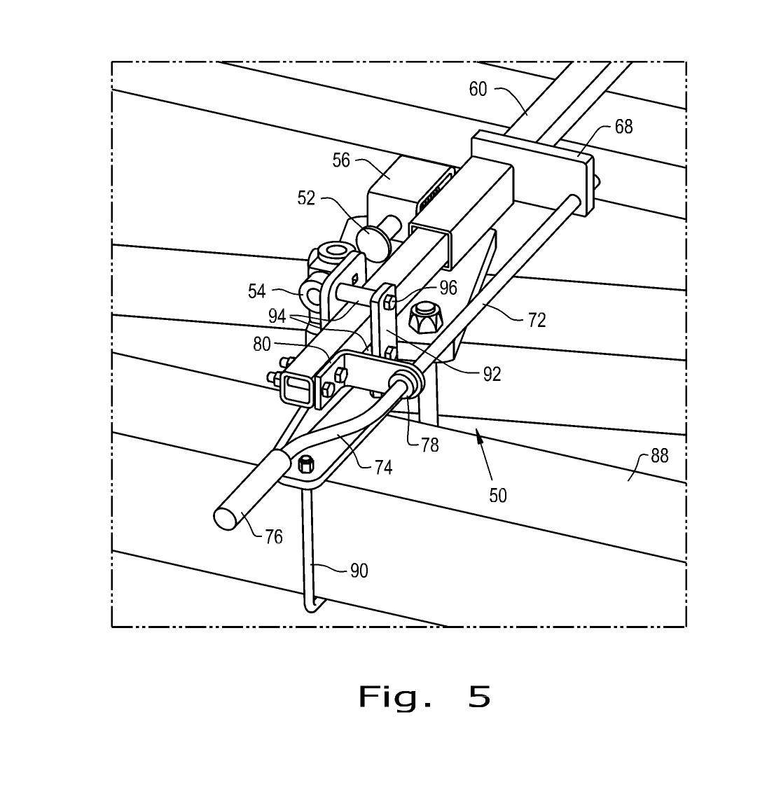

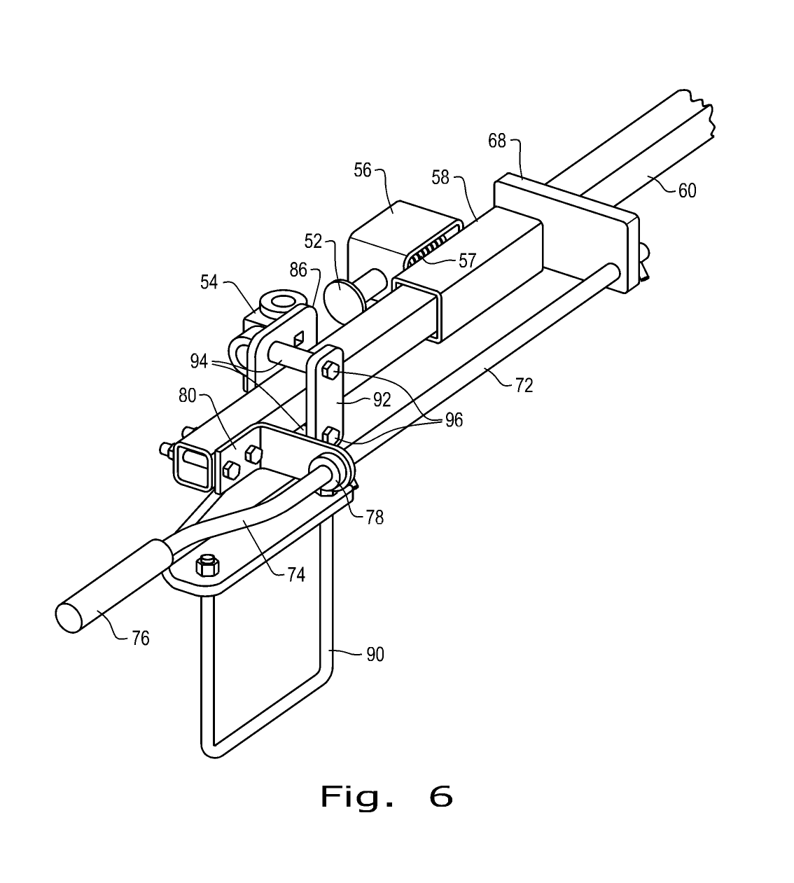

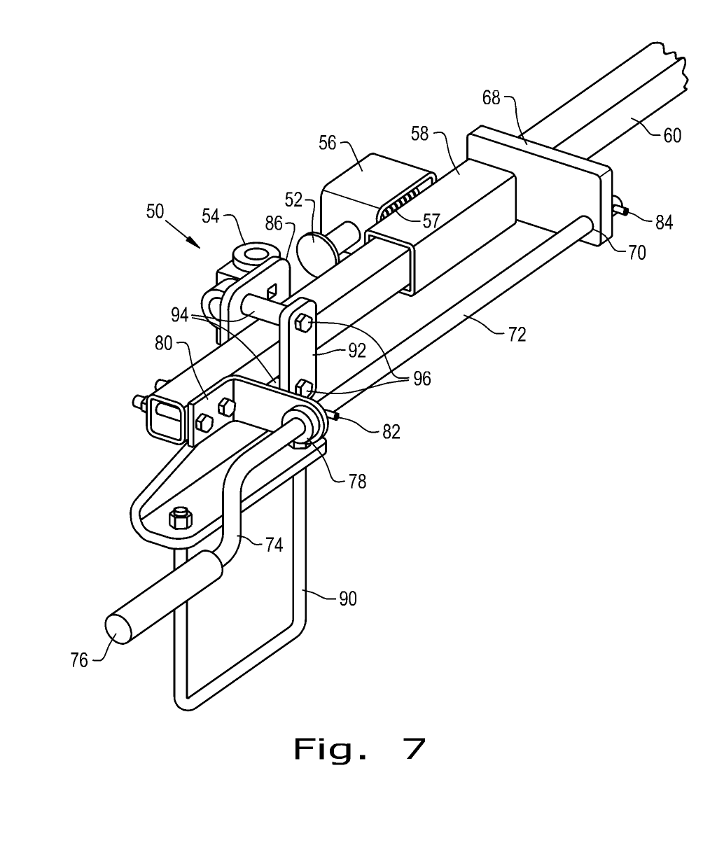

Referring now to FIGS. 3-7, there is shown an embodiment of a single point depth control assembly 50 of the present invention. In the illustrated embodiment, depth control assembly 50 is in the form of a hydraulic depth control assembly, and generally includes a plunger 52 which engages a hydraulic valve 54 to manually set a tillage depth in the soil. Plunger 52 is reciprocally coupled with and movable relative to a mechanical stop 56 attached to a slide 58. A spring 57 within the mechanical stop 56 surrounds the shaft of the plunger 52 and biases the plunger 52 toward the hydraulic valve 54. Slide 58 slides along a tube 60 attached at an opposite end 62 thereof to a rocker arm 64 which rotates with an axle 66 as the tillage implement is raised up and down. The tube 60 is shown as a hollow tube in the illustrated embodiment, but it will be appreciated that the tube 60 can also be solid and/or have different cross sectional shapes.

Slide 58 is attached to a foot 68 which has an internally threaded opening 70 which engages external threads (not shown) on rod 72. At an opposite end of rod 72 is a crank arm 74 with a distal end carrying a heavy metal handle 76. Handle 76 is sized for an ergonomic fit and is heavy enough to act as a ballast such that handle 76 remains in a down position during operation within a field, thereby preventing inadvertent rotation of rod 72 after the desired depth is set. A ring shaped shoulder 78 abuts an L-shaped flange 80 which is bolted to the distal end of tube 60, and acts as a stop surface when plunger 52 engages the valve 54. Retainer pin 82 prevents axial movement of rod 72 in the opposite direction relative to flange 80, and retainer pin 84 prevents the rod 72 from being inadvertently unscrewed from within the threaded opening 70 of foot 68.

The hydraulic valve 54 is rigidly connected with a bracket 86, which in turn is rigidly connected with a frame member 88 using a U-bolt 90. A further bracket 92 is connected with the bracket 86 using standoffs 94 and bolts 96, which is configured to allow sliding movement of the tube 60 within a clearance distance which is provided between the brackets 86 and 92.

To adjust the spacing between plunger 52 and valve 54, threaded rod 72 is turned clockwise or counter-clockwise by grasping handle 76 and turning crank arm 74. Handle 76 can be rigidly affixed to the end of crank arm 74, or can rotate relative to crank arm 74 for easier cranking and adjustment. The selected spacing between plunger 52 and valve 54 in turn sets the tillage depth. Handle 76 is simply released when the desired spacing is reached, and the weight of handle 76 effectively prevents inadvertent adjustment of the depth control assembly 50 during operation of the tillage implement 14. As the tillage implement is lifted up and down, axle 66 rotates which causes the outboard end of rocker arm 64 to pivot fore and aft, which it turn causes tube 60 to slide fore and aft between the brackets 86 and 92. Plunger 52 engages hydraulic valve 54, depending on the selected operating depth using depth control assembly 50, and thereby sets the operating tillage depth.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An agricultural tillage implement, comprising:
a carriage frame assembly including a pull hitch extending in a travel direction;
an axle with a rocker arm extending therefrom;
a tube pivotally attached to an end of the rocker arm; and
a depth control assembly associated with said tube, said depth control assembly including a slide surrounding said tube and slidably movable along said tube, and a rod threaded with an opening associated with said slide, said rod having an opposing end with a crank arm and a handle at a distal end of said crank arm, said handle being configured as a ballast to prevent inadvertent adjustment of said depth control assembly during operation of the tillage implement.

2. The agricultural tillage implement of claim 1, wherein said depth control assembly includes a plunger associated with said slide, and a hydraulic valve which is actuated by said plunger at a desired operating depth of the tillage implement.

3. The agricultural tillage implement of claim 2, wherein said depth control assembly includes a mechanical stop attached to said slide and a spring within said mechanical stop, said plunger being reciprocally attached to said mechanical stop and said spring biasing said plunger toward said hydraulic valve.

4. The agricultural tillage implement of claim 2, wherein said hydraulic valve is rigidly connected to a bracket, and said bracket is rigidly connected to a frame member.

5. The agricultural tillage implement of claim 4, further including a further bracket which is spaced apart from and connected to said bracket using a pair of standoffs and a pair of bolts, and wherein said tube is slidable within a clearance distance provided between said bracket and said further bracket.

6. The agricultural tillage implement of claim 1, including a foot attached to and extending from said slide, said opening being an internally threaded opening extending through said foot.

7. The agricultural tillage implement of claim 6, further including an L-shaped bracket attached to a distal end of said tube, and wherein said rod extends through said L-shaped bracket.

8. A depth control assembly for use with an agricultural tillage implement having a carriage frame assembly including a pull hitch extending in a travel direction, and an axle with a rocker arm extending therefrom, said depth control assembly comprising:
a tube pivotally attached to an end of the rocker arm;
a slide surrounding said tube and slidably movable along said tube; and
a rod threaded with an opening associated with said slide, said rod having an opposing end with a crank arm and a handle at a distal end of said crank arm, said handle being configured as a ballast to prevent inadvertent adjustment of said depth control assembly during operation of the tillage implement.

9. The depth control assembly of claim 8, further including a plunger associated with said slide, and a hydraulic valve which is actuated by said plunger at a desired operating depth of the tillage implement.

10. The depth control assembly of claim 9, including a mechanical stop attached to said slide and a spring within said mechanical stop, said plunger being reciprocally attached to said mechanical stop and said spring biasing said plunger toward said hydraulic valve.

11. The depth control assembly of claim 9, wherein said hydraulic valve is rigidly connected to a bracket, and said bracket is rigidly connectable to a frame member.

12. The depth control assembly of claim 11, further including a further bracket which is spaced apart from and connected to said bracket using a pair of standoffs and a pair of bolts, and wherein said tube is slidable within a clearance distance provided between said bracket and said further bracket.

13. The depth control assembly of claim 8, including a foot attached to and extending from said slide, said opening being an internally threaded opening extending through said foot.

14. The depth control assembly of claim 13, further including an L-shaped bracket attached to a distal end of said tube, and wherein said rod extends through said L-shaped bracket.
